(19) United States
(12) Patent Application Publication
(10) Pub. No.: US 2004/0249065 A1
(43) Pub. Date: Dec. 9, 2004

(54) Biodegradable plastics

(76) Inventors: Christopher H. Schilling, Midland, MI (US); David S. Karpovich, Gagetown, MI (US); Piotr Tomasik, Cracow (PL)

Correspondence Address: MCKELLAR STEVENS & HILL PLLC, POSEYVILLE PROFESSIONAL COMPLEX, 784 SOUTH POSEYVILLE ROAD, MIDLAND, MI, 48640, US

(21) Appl. No.: 10/457,281

(22) Filed: Jun. 9, 2003

(51) Int. Cl. C08L 89/00

(52) U.S. Cl. 525/54.1; 525/56; 525/57; 523/128

(57) ABSTRACT

A method for producing biodegradable plastic from natural materials containing polysaccharides and oligosaccharides by treating the polysaccharide-containing or oligosaccharide-containing materials with a basic aqueous solution, subsequently treating the mixture with a modifying material to create an anionic product, and then contacting the anionic product with proteins to produce the biodegradable plastic material. The process provides relatively inexpensive methods for preparing biodegradable plastics that are useful for manufacturing various articles and also to provide an environmental solution that will reduce the amount of natural wastes that could be practically utilized for the benefit of mankind.

The invention disclosed and claimed herein deals with methods of preparing biodegradable plastics and the biodegradable plastics per se,

The essence of this invention is to provide relatively inexpensive methods for preparing biodegradable plastics that are useful for manufacturing various articles and also to provide an environmental solution that will reduce the amount of natural wastes that could be practically utilized for the benefit of mankind, rather than having to place such wastes in a landfill or otherwise having to dispose of them.

### BACKGROUND OF THE INVENTION

The World has been blessed with the capability of providing various products that benefit mankind such as foods for human consumption, beverages, animal feeds, building materials, and the like. A huge downside to this blessing is the fact that in the manufacture of these materials, large amounts of waste are created, and typically, these wastes are burned or buried in order to get rid of them. It now becomes environmentally and economically necessary to consider ways in which these wastes can be removed and at the same time, create products or byproducts that can be recycled back into commerce or can otherwise be beneficial to mankind.

For economical and environmental reasons, recent studies focus on utilization of natural materials, either in the natural state, or as a waste stream from the processing natural materials as renewable, versatile, biodegradable resources for the production of novel materials. Polysaccharides and oligosaccharides are a major part of these natural materials and flora containing such polysaccharides and oligosaccharides are commonly combusted to generate heat energy or electric energy through the use of gasifier units utilizing heat exchangers. Also, composting is an alternative approach to utilization of biomasses.

Polysaccharides and oligosaccharides are increasingly used as a source of raw material for the chemical industry whereby they are converted to useful products. Examples of such materials include the processing of novel materials from wood cellulose, hemicelluloses of straw, grass, leaves, fruits and vegetables, and starch of cereals and tubers.

Several attempts have been made to utilize polysaccharides and oligosaccharides for the formation of biodegradable plastics. For example, in an early article, Albertson and Ranby describe the formation of polyethylene foils with starch granules sealed inside the polyethylene. A. C. Albertson and B. Ranby, (1979), J. Appl, Polym. Sci., 35, 413-430. However, this method has been nearly completely abandoned because only the starch component biodegraded leaving powdered polyethylene behind in the environment.

There has been reported by Satkofsky the development of biodegradable plastics from poly(vinyl alcohol), polycarbonates, and poly(lactic acid) reaction products of polysaccharides proteins. A. Satkofsky, (2002). J. Comp. Org. Recycl., 43 (3), 60.

Additionally, there has been reported the modification of proteins. J. Jane and S. T. Tim, (1995). Progress in Plant Polymeric Carbohydrate Research (eds. F. Meuser, D. J. Munnes, and W. Seibel), Behr's Verlag, Hamburg, pp. 165 -168; C. H. Schilling, T. Babcock, S. Wang, and J. Jane, (1995). J. Mater. Res. 10, 2197-2202 and J. Zhang, P. Mungara, P., and J. Jane, (2000). Polymer, 42, 2569-2578.

Reaction products of proteins with polysaccharides and oligosaccharides requires that the polysaccharides and oligosaccharides are anionic. Recently, several protein/anionic polysaccharide reaction products were synthesized by an electrochemical method. For example, potato starch, pectins, xanthan gum, carrageenans, and carboxymethyl cellulose served as anionic polysaccharide components that were used in forming reaction products with proteins. A. Dejewska, J. Mazurkiewicz, P. Tomasik, and H. Zaleska, (1995) Staerke, 47, among others.

Applicants are aware of several patents that describe the preparation of polymers and biodegradable plastics therefrom. U.S. Pat. No. 5,166,336, issued Nov. 24, 1992 to Yamauchi, et al., describes a process for producing a corn milling residue carboxymethylether salt comprising reacting a corn milling residue with alkali in the presence of an aqueous carboxymethylating agent solution to give a corn milling residue carboxymethylether salt with an average degree of substitution of not less than 0.2.

In a first U.S. Pat. No. 5,397,834 to Jane, et al, that issued on Mar. 14, 1995, there is described a biodegradable, thermoplastic composition made of the reaction product of a starch aldehyde with protein.

U.S. Pat. No. 5,710,190, that issued Jan. 20, 1998 also to Jane, et al., deals with a biodegradable thermoplastic composite made of soy protein, a plasticizing agent, a foaming agent, and water, that can be molded into biodegradable articles that have a foamed structure and are water-resistant with a high level of physical strength and/or thermal insulating properties.

There is disclosed in U.S. Pat. No. 5,852,114, that issued Dec. 22, 1998 to Loomis, et al., a biodegradable thermoplastic polymer blend in which a first polymer and a second polymer are intimately associated together in a uniform, substantially homogeneous blend. The composition may further comprise a polysaccharide component such as starch.

In addition, biodegradable polymers are described in U.S. Pat. No. 6,482,872 that issued on Nov. 19, 2002 to Downie. The patent describes a process for manufacturing polymers containing a degradable component that increases the rate of polymer degradation.

Finally, applicants are aware of a U.S. Pat. No., 6,103,885, that issued Aug. 15, 2000 to Batelaan, et al, in which there is described a process for the amidation of a material having at least one carboxyl-containing polysaccharide. The carboxy groups are reacted with an ammonium donor of the general formula—NH to form the corresponding polysaccharide carboxyl ammonium salt, and a second step in which the polysaccharide carboxy ammonium salt is heated so as to convert the ammonium groups into the corresponding amido groups.

It does not appear that any of the aforementioned citations deal with the processes or inventive materials of the instant invention.

Distiller's dry grain is a by-product or waste product from the manufacture of ethanol from corn. Significant growth in the worldwide production of distiller's dry grain is anticipated as a result of rapid growth in the mass production of corn-derived ethanol for transportation fuel. Currently, the main use of this material is as an animal feed. It can also be incorporated into human snack food and spaghetti, and in one instance, it has been reported as an extender and thickener in urea-formaldehyde plywood adhesives.

Also, corncobs are usually considered waste material from industrial utilization of maize crops. Several applications of corncobs have been reported in the literature. For example, pulverized corncobs were admixed with various glues and petroleum-derived fibers to produce lignocellulosic composites. Polypropylene and other engineering polymers have been reinforced with pulverized corncob fiber and attempts to use shredded corncobs in paper making have also been published.

Corncobs, being largely cellulose and hemicellulose possess excellent absorbing properties and have been used in a variety of applications as absorbents, animal bedding, stove and furnace fuel, and as a carrier of agricultural fertilizers. They have also been transformed to charcoal and subsequently used as a sorbent. Pyrolysis of corncobs results in the production of furaldehyde and acetic acid. Enzymatic treatment of corncobs provides acetone and butanol as well as D-xylan and D-xylose. They are commonly pulverized into fine powder particles that are subsequently used as industrial abrasives.

Corncobs contain approximately 47% cellulose in their woody fraction, and 36% cellulose in the pith and chaff fraction. In both fractions, approximately 37% hemicelluloses and 35 to 36% pentosans exist.

There should also be considered, hardwood sawdust. Hardwood sawdust is a voluminous waste material of the forest products industry. Several value-added applications of sawdust have been reported in the literature. For example, the production of solid fuel by briquetting or pelletizing sawdust is common. Co-fermentation of sawdust with manure and co-liquefaction with coal are alternative routes to energy production.

The sorptive properties of sawdust resulted in its application as a collector of heavy metals and other toxins from wastewater and soil, and in addition, charcoal can be manufactured from sawdust. The use of sawdust as construction material for wood product boards and panels has been known since the nineteenth century. Recent developments include the use of sawdust for reinforcing polymers and as a component of wood-based cement-bonded boards.

There are many other natural sources of polysaccharides and oligosaccharides, including leaves, bark, roots, straw, shells of seeds, stems of plants, and especially sugar beet pulp as a large volume from the production of sugar from sugar beets. Although a large amount of this pulp is utilized as animal feed, the production of L-arabinose, and the production of paper, this utilization is not enough to significantly reduce the amount of such waste.

### BRIEF DESCRIPTION OF THE DRAWINGS

FIG. 1 are reproductions of infrared spectra of original DDG (top graph), original soy protein isolate (center graph), and DDG soaked in aqueous solution of NaOH (bottom graph).

FIG. 2 are reproductions of infrared spectra of DDG derivatized with glutaric anhydride (top graph) and the reaction product of glutarated DDG with soy protein isolate (bottom graph).

FIG. 3 are reproductions of infrared spectra of carboxymethylated DDG (top graph) and the reaction product of carboxymethylated DDG with soy protein isolate (bottom graph).

FIG. 4 is a scanning electron micrograph reproduction of maleinated DDG after compression with soy protein isolate.

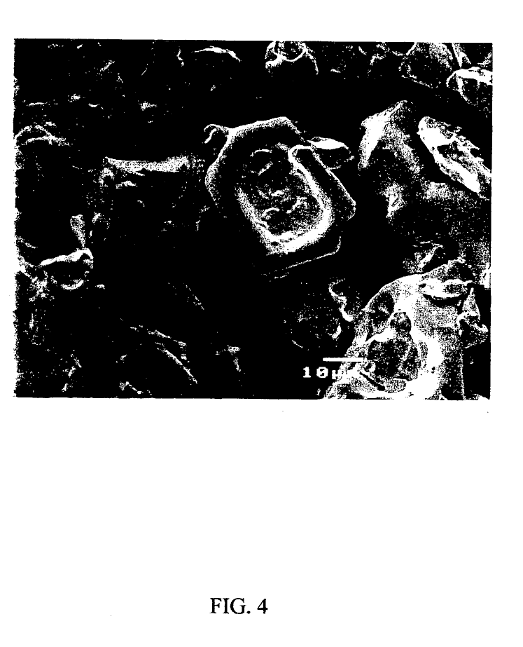

FIG. 5 are reproductions of infrared spectra of corncob powder (top graph), the reaction product of succinylated corncob powder with soy protein isolate (center graph), and the reaction product of carboxymethylated corncob powder with soy protein isolate (bottom graph).

FIG. 6 are reproductions of infrared spectra of hardwood powder (top graph), the reaction product of glutarated hardwood powder with soy protein isolate (middle graph) and the reaction product of carboxymethylated hardwood powder with soy protein isolate (bottom graph).

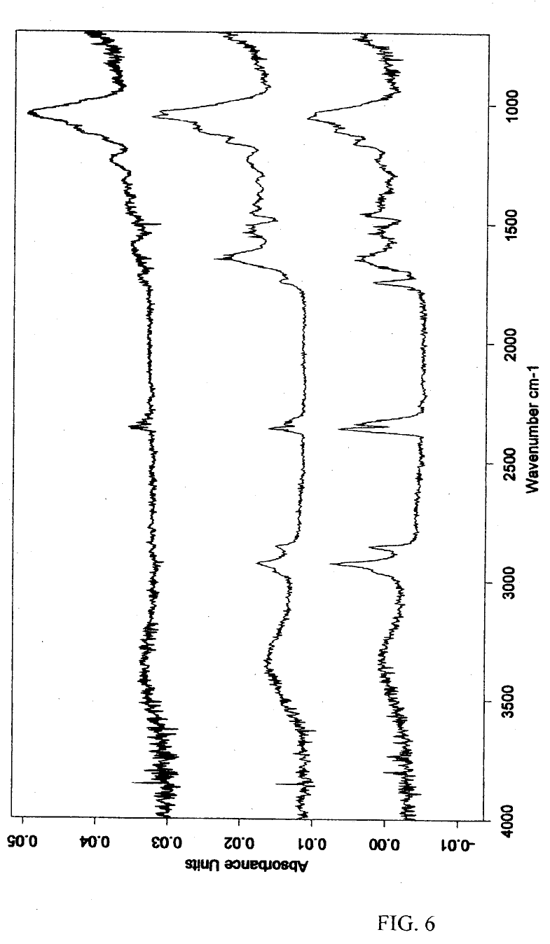

FIG. 7 are reproductions of infrared spectra of as-received and pulverized corn distillers' dry grain (top graph), corn distillers' dry grain soaked in aqueous NaOH solution (second from the top graph), soy protein isolate (middle graph), oxidized corn distillers' dry grain (fourth graph from the top), and the reaction product of oxidized corn distillers' dry grain with soy protein isolate (bottom graph).

FIG. 8 are reproductions of infrared spectra of as-received and pulverized hardwood powder (top graph), oxidized hardwood powder (center graph), and the reaction product of soy protein isolate with oxidized hardwood powder (bottom graph).

FIG. 9 are reproductions of infrared spectra of as-received corncob powder (top graph), oxidized corncob powder (center graph) and the reaction product of soy protein isolate with oxidized corncob powder (bottom graph).

FIG. 10 are reproductions of infrared spectra of as-received and pulverized sugar beet pulp (top graph), as-received and pulverized sugar beet pulp soaked in aqueous NaOH solution (second graph from the top), a reaction product of oxidized sugar beet pulp with soy protein isolate (third graph from the top), and oxidized sugar beet pulp (bottom graph).

### THE INVENTION

The invention disclosed and claimed herein is a method for producing biodegradable plastic from natural materials containing polysaccharides and oligosaccharides by treating the polysaccharide-containing or oligosaccharide-containing material with a basic aqueous solution, subsequently treating the mixture with a modifying material, to create an anionic product, and then contacting the anionic product with proteins to produce the biodegradable plastic material.

With more specificity, this invention deals with a method for the preparation of biodegradable plastics, the method comprising (I) providing a suspension in a basic aqueous carrier of a finely divided natural material containing polysaccharides and/or oligosaccharides and (II) adding water to the suspension and (III) agitating the suspension for a period of time and then, (IV) subjecting the product resulting from step (III) to derivatization selected from the group consisting of (A) acylation using materials selected from a group consisting of cyclic anhydrides of (i) maleic acid, (ii) succinic acid, (iii) glutaric acid, (iv) phthalic acid, and (v) derivatives of (i), (ii), (iii), and (iv); (B) carboxymethylation using materials selected from the group consisting of: (i) haloalkanoic acids and (ii) salts of haloalkcaoic acids, and, (C) oxidation using an oxidizing agent selected from the group consisting of (a) hypochlorites, (b) hydrogen peroxide, (c) ozone and (d) air, to provide a solid anionic material.

Thereafter, there is a step (V) consisting of combining the material resulting from (IV) with a protein and allowing the resulting material and the protein to react with each other to form the biodegradable plastic product.

It should be noted by those skilled in the art that steps I and II can be combined, depending on the composition of the starting natural material.

The method of this invention is applicable to a wide range of natural materials. The materials can be, for example, starchy materials, cellulose materials, lignocellulosic materials, hemicellulosic containing materials, and plant gum containing materials. Included in, but not limited to, are the polysaccharide-containing materials such as plant tubers, wheat, seed, shells of seeds, stems, roots, and leaves of plants, fruits and their skins, wood, tree branches, tree bark, straw, grass, and waste materials originating from the agricultural industry, for example, distiller's dry grain, sugar beet pulp, cellulose pulp, paper waste, cotton, linen, vegetables and vegetable waste, such as tomato skins and seeds, and the like.

According to the method, these materials, or any one of them, are pulverized, ground, or minced, to render them into smaller particle sizes and then the minced material is suspended in a basic aqueous solution, for example metal hydroxides such as sodium hydroxide, potassium hydroxide and the like. The concentration of the aqueous basic solution should correspond to that resulting from the stoichiometry of reactions used for derivatization of the material and the amount of derivatizing reagent used. Water is subsequently added to the solution, which is then agitated at room or elevated temperatures. For example, room temperature agitation should last 12 to 24 hours. It should be noted by those skilled in the art that steps I and II can be combined, depending on the composition of the starting natural material.

Thereafter, the saccharide component in the agitated suspension is subjected to derivatization, which converts the saccharide into an anionic substance. Methods of derivatization include (i) acylation by reaction with the cyclic anhydrides described Supra, and derivatives of such anhydrides, (ii) carboxymethylation with haloalkanoic acids and their salts, for example, chloroacetic acid, bromosuccinic acid, iodomalonic acid, and the like, and (iii) oxidation of the material with an oxidizing agent, for example, hypochlorites, hydrogen peroxide, ozone, or air.

The reagent concentration ranges from 10⁴ to 10² moles per 10 grams of original saccharide material being derivatized. The reaction mixture is agitated at room temperature for up to 24 hours. A solid reaction product is subsequently separated from the reaction mixture by filtration, centrifugation or decantation.

Thereafter, the derivatized material can be transferred into another reaction vessel and subjected to one of two procedures comprised of reacting with protein using the derivatized saccharide.

Protein materials may be any that are readily available and may include soy protein isolate, casein separated from or dispersed in milk, whey protein isolate, whey protein, potato protein, ovalbumnin and animal albumins, protein in blood from slaughter houses, molasses raffinate, and the like. The derivatized saccharide material can be suspended in water and subsequently admixed with solid protein.

The second possibility is that the derivatized saccharide is admixed with an aqueous solution of protein. In both cases, the protein concentration is in the range of from 0.1 to 500 weight percent of the original derivatized saccharide material. The exact proportion will depend on the degree of derivatization of the original saccharide. After blending, the reaction mixture is agitated for 1 to 24 hours at room or elevated temperature, followed by isolation of a reaction product that is a saccharide/protein reaction product, that has a paste-like consistency. The isolation can be carried out by centrifugation, pressure filtration, decantation, or the like.

The resulting wet paste is then subjected to one of two procedures for plastic shaping, that is, it can be directly shaped by hand molding or by injection into a forming die and subsequently dried into a hard material, or, the west paste can be dried into hard fragments, subsequently pulverized into a powder, and then subsequently reconstituted into paste by the addition of water, and subsequently molded and/or injected into a forming die. The material is subsequently dried into a hard material, or the derivatized saccharide is directly molded or shaped without blending with protein. The wet paste can be processed by two alternative methods, namely, the west paste can be directly shaped by either hand molding or by injection into a forming die, or the wet paste can be slightly acidified in order to increase the number of crosslinking ester bonds and subsequently heated and shaped by either hand molding or by injection into a forming die. In both cases, the material is subsequently dried into a hard material.

As used in the following examples, reagent grade glutaric, maleic, phthalic, and succinic anhydrides and sodium chloroacetate were provided by Aldrich Chemical, Milwaukee, Wis.

Isolated Soy Protein having the designation 066-974, PRO-FAM 974 was provided by Protein Specialties Division, Archer Daniels Midland Company, Decatur, Ill. and contained 6% moisture, 90% protein, 5% total fat, and 5% ash. The pH of the material was 7.0 to 7.4.

IR spectra: Infrared Spectra were measured using a Bruker Equinox 55 (Bruker, Madison, Wis., U.S.A.) Fourier Transform Infrared spectrometer fitted with a Pike Technologies Attenuated Total Reflectance attachment. Spectra were recorded with 32 scans at 4 cm⁻¹ resolution.

Samples were evaluated with a Differential Scanning Calorimeter DSC 550E from Instrument Specialists Inc., Spring Grove, Ill. from room temperature to 250° C. at a heating rate of 20° C. per minute. These measurements were obtained on solid samples contained in open pans in a stream of nitrogen.

Scanning Electron Microscopy imaging was performed using a JSM-5400 scanning electron microscope from Jeol USA Inc. Peabody, Mass. Samples were gold sputtered for 5 minutes to reduce charging

Mechanical property testing such as the tensile strengths of individual pellets was measured by the diametric compression method. Individual pellets were compressed between flat compression platens in a computer-instrumented mechanical testing machine model 1125, Instron Corporation, Canton, Mass. At least 10 separate specimens of each specimen composition were subjected to mechanical testing. During each test, the displacement rate of the compression platens was 5 mm/min. Load versus displacement data were computer recorded for each compression test. The fracture strength, S_{f} of each specimen was determined by the following formula δ_{f}=2P/(πDt) wherein P is the load at fracture, D is the pellet diameter, and t is the pellet thickness.

### EXAMPLES

### Example 1

### Conversion of Distiller' Dry Grain

Distillers' Dry Grain (Dakota Gold DDG obtained from Dakota Commodities Incorporated, Scotland, S. Dak., that contained 88.38% dry matter with 30% crude protein, 12% crude fat and 5.38% ash was pulverized in a kitchen blender prior to use.

Acylation

The DDG powder, 50 gm. was suspended in either 0.1 or 1.0 M aqueous NaOH solution (50 ml) and agitated for 24 hours at room temperature in a closed flask. Subsequently, deionized water (125) ml and 0.1 mole of one of the following acyl anhydrides was admixed to the suspension: glutaric, maleic, phthalic, and succinic anhydride. The reaction mixture was subsequently agitated for 24 hours in a sealed flask, followed by centrifugation for 30 minutes at 6000 rpm. Supernatants were decanted and the resulting centrifuge cakes were dried in air at 50° C.

Carboxymethylation

DDG powder, 50 gm. was suspended in deionized water, 175 ml., and solid NaOH, (4.5 gms.) was subsequently added. The reaction mixture was agitated for 6 hours at room temperature in a closed flask, followed by the addition of sodium chloroacetate, 0.1 mole. The reaction mixture was subsequently agitated for 12 hours in a sealed flask, followed by centrifugation for 30 minutes at 6000 rpm. Supernatants were decanted and the resulting centrifuge cakes were dried in air at 50° C.

Reaction Product Formation in Aqueous Solution

Five grams of isolated soy protein was dissolved in 100 ml of deionized water and 5 gms of the DDG derivative prepared above, was admixed therewith. The reaction mixture was agitated for 24 hours in a closed container, followed by centrifugation for 30 minutes at 6000 rpm. Supernatants were decanted and the resulting centrifuge cakes were transferred with a spatula into a pellet mold placed on a flat ceramic surface. The mold consisted of a flat acrylic sheet of 8 mm thickness that was perforated with individual 12.5 millimeter round holes. The filled mold was subsequently dried in air at room temperature for 24 hours. Moist pellets were then transferred to an oven and dried in air at 50° C. Ten pellets were prepared from each reaction product for subsequent mechanical property measurements.

Reaction Product Formation by Compression

A separate set of pellets was prepared by mechanical compression using three types of powder: (i) pulverized DDG powder; (ii) pulverized DDG that was treated with 0.1 M aqueous NaOH solution for 24 hours and then air dried, and (iii) pulverized DDG that was derivatized by either carboxymethylation or acylation. Samples (i), (ii), and (iii), 3 gms. each, were blended with 3 gms of isolated soy protein and 1 gm. of water in a sealed polyethylene container for 24 hours. Uniaxial compression was subsequently performed in a cylindrical die of 9.525 mm diameter made of precision machined stainless steel. A weighed amount of each blend was individually compressed at 1.2 GPa for 5 minutes using a hydraulic press (Model C Laboratory Press, Fred Carver Inc. Menominee Falls, Wis.).

The addition of the derivatized DDG to solutions of the soy protein isolate immediately resulted in the precipitation of a solid reaction product. This occurred with all derivatized DDG specimens of this example. No reaction products precipitated after blending non-derivatized DDG with protein solution.

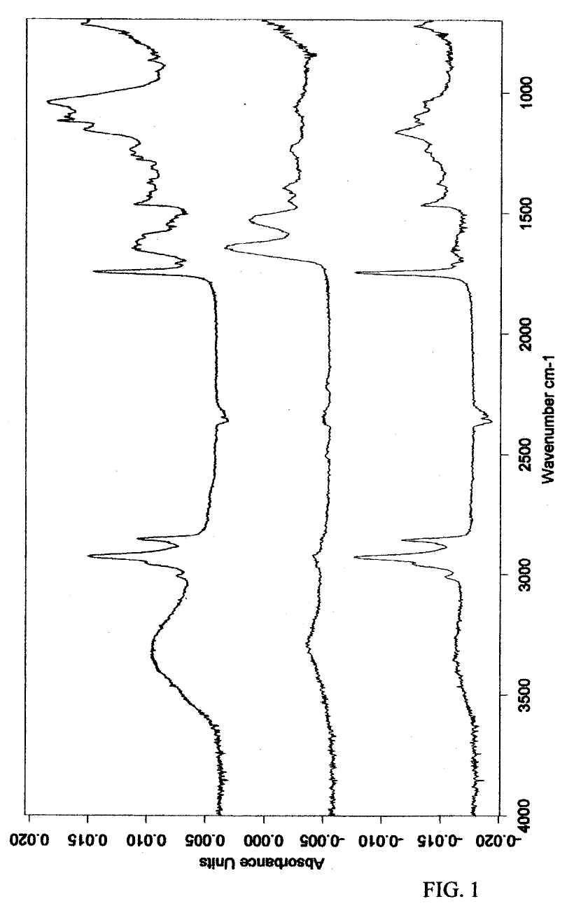

Qualitative evaluation of the derivatization of DDG was based on IR analysis. FIG. 1 represents the IR spectrum of pulverized DDG before derivatization. The spectrum particularly in the regions of 1000 to 1200, 1200 to 1500, and 1500 to 1600 cm⁻¹ strongly resemble spectra of polysaccharides and oligosaccharides. These bands can be ascribed to C—O stretching, OH bending, and C═O stretching modes, respectively. Protein present in DDG may be shown by bands incorporated in the region of 1500 to 1700 cm⁻¹ in FIG. 1. This is suggested from comparison of the spectrum of pulverized DDG with the spectrum of soy protein isolate in FIG. 1.

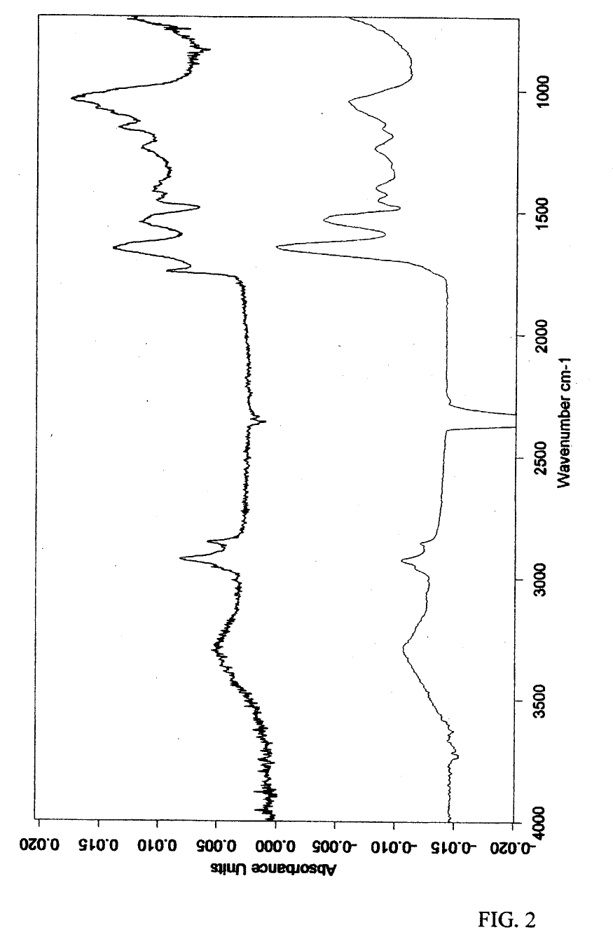

FIG. 2 illustrates changes in the IR spectrum of DDG resulting from glutaration. In particular, the C═O stretching vibrations between 1500 and 1600^{cm-}1 increased in intensity relative to the rest of the spectrum, and the C—O stretching region changed slightly, which is possibly due to the addition of specific C═O vibrations from the addition of glutaric anhydride. Similar changes were observed in IR spectra of DDG resulting from other acylations that are not shown. Upon reacting glutarated DDG with soy protein, further changes in the IR spectrum occurred. In particular, the protein C═O band intensities increased in the region of 1500 to 1700 cm⁻¹. Furthermore, the band at 1750 cm⁻¹ disappeared; this band can be attributed to an acid or ester C═O stretch, and its disappearance may indicate reaction of those groups to other forms. Subtle changes in the group of vibrations corresponding to the C—O stretch (1000 to 1200 cm⁻¹) and OH bend (1200 to 1500 cm⁻¹) of the hydroxyl groups may also suggest interaction of these groups with protein. Again, similar changes in these groups of bands were observed in IR spectra of DDG resulting from all other acylations.

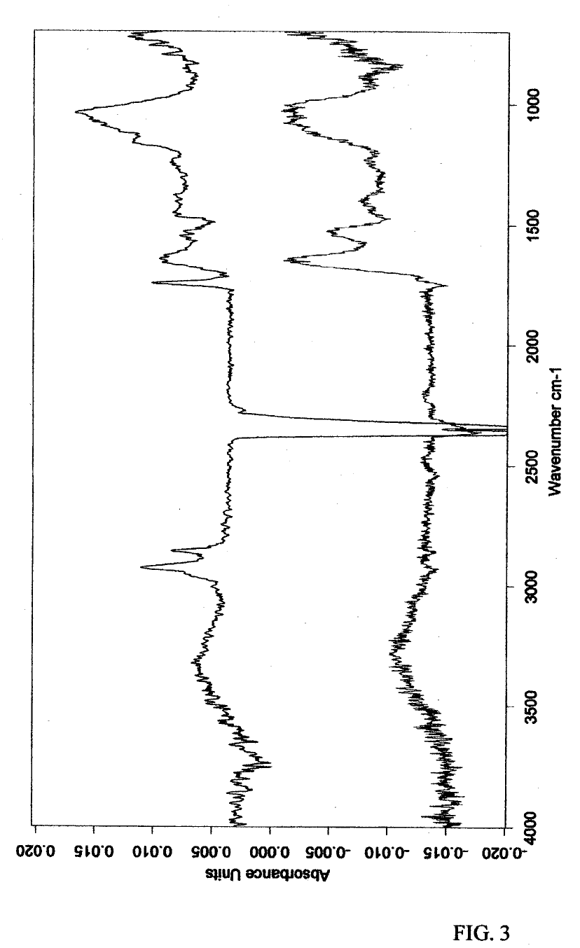

FIG. 3 shows the changes by carboxymethylation of DDG. Subsequent reaction product of carboxymethylated DDG with soy protein isolate evoked further changes in the IR spectrum. The most significant changes again were the appearance of protein bands and the vanishing free acid or ester C═O band at 1750^{cm-}1.

In most cases, crack-free pellets were made by drying pastes that were previously isolated from aqueous suspensions of reaction products. Drying shrinkages are reported in Table 1 for all specimens except those resulting from carboxymethylation. Pellets that were made of DDG maleinated in 1.0 M NaOH solution exhibited the highest shrinkage and simultaneously the highest strength. In contrast, maleination in 0.1 M NaOH solution led to pellets with minimum shrinkage and minimum strength. Glutaration, phthalation, and succinylation let to pellets that were slightly weaker than pellets resulting from maleination in 1.0 M NaOH.

Formation of reaction products of derivatized DDG with soy protein isolate was also attempted by uniaxial compression at 1.2 GPa. All pellets prepared by such compression were very weak and readily disintegrated.

TABLE I
Results of mechanical tests of pellets made of
DDG reaction products with soy protein isolate

| | AVERAGE PELLET SIZE | | |
|---|---|---|---|
| DERIVATIZED DDG | DUE TO SHRINKAGE^{a} | | TENSILE |
| IN REACTION | DIAMETER | THICKNESS | STRENGTH |
| PRODUCTS | mm | mm | MPa |
| Carboxymethylated^{b} | — | — | — |
| Maleinated^{c} | 10.3 ± 0.1 | 6.1 ± 0.2 | 0.22 ± 0.1 |
| Maleinated^{d} | 8.9 ± 0.3 | 4.2 ± 0.3 | 1.67 ± 0.7 |
| Glutarated | 9.2 ± 0.3 | 5.6 ± 0.3 | 1.39 ± 0.4 |
| Phthallated | 9.2 ± 0.2 | 4.4 ± 0.2 | 1.21 ± 0.4 |
| Succinylated | 9.1 ± 0.2 | 4.6 ± 0.2 | 1.27 ± 0.4 |

^{a}Original size of cylindrical pellets was 12.5 mm diameter by 8 mm thick.
^{b}No pellets suitable for measurements could be formed because of significant shrinkage
^{c}Pellets made of DDG soaked in 0.1 M aqueous NaOH solution prior to derivatization.
^{d}Pellets made of DDG soaked in 1 M aqueous NaOH solution prior to derivatization.

### Example 2

### Corncob Powder

Corncob powder designated as 820R Lite-R-cob was purchased from the Anderson's Corncob Products, Maumee, Ohio. The product had a specific gravity of 0.8 to 1.2 and a moisture content of 10%, a particle size distribution of 3% of 3 mesh, 5% of 5 mesh, 10% of 8 mesh, 60% of 10 mesh, 15% of 20 mesh, and 5% of 30 mesh.

Acylation was carried out essentially as set forth in Example 1 using 50 grams of corncob in 50 ml of 1.0 M aqueous NaOH solution.

Carboxymethylation was carried out by using 50 grams of corncob powder and suspending it in deionized water (175 ml) with solid NaOH (4.5 grams). The reaction mixture was agitated for 6 hours at room temperature in a closed flask, followed by the addition of sodium chloroacetate (either 0.1 or 0.2 mole). The reaction mixture was subsequently agitated for 12 hours in a sealed flask, followed by centrifugation for 30 minutes at 6000 rpm. Supernatants were decanted and the resulting centrifuge cakes were dried in air at 50° C.

The formation of reaction products of the derivatized corncob powder and isolated soy protein was carried out as in Example 1.

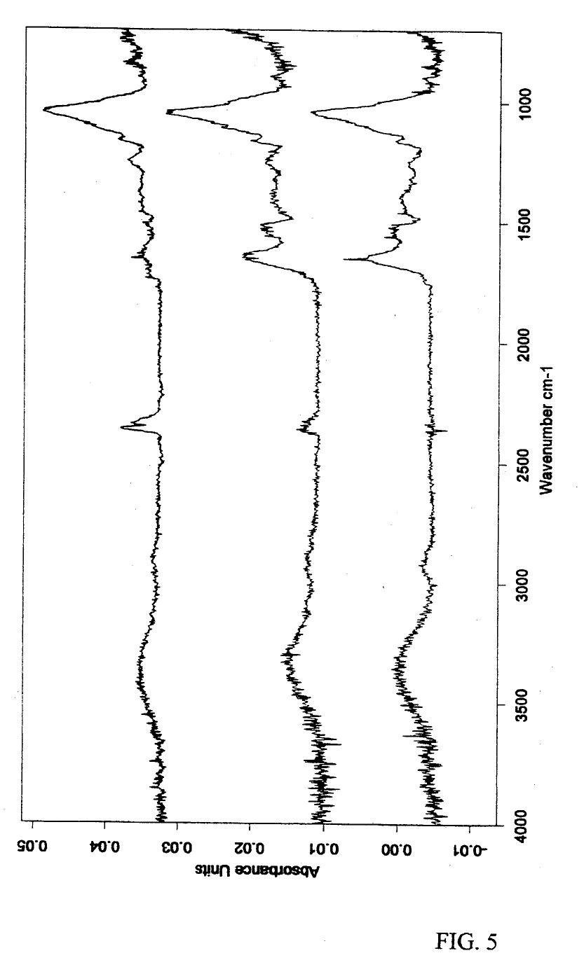

With reference to FIG. 5, infra red analysis showed a pattern that revealed the polysaccharide character of the material. In particular, bands at 1000 and 1500 to 1600 cm⁻¹ typify hydroxyl group vibrations of polysaccharides and oligosaccharides.

Changes in the spectrum were caused by the reaction of acylated corncob powder.

FIG. 5 illustrates this observation in the case of succinylated corncobs. Evident is the appearance of C═O peaks from the succinic anhydride as well as protein bands (1500-1700 cm⁻¹). The presence of these peaks supports the formation of a complex between protein and succinylated corncob. Essentially the same spectral changes were observed for reaction products of soy protein with the other acylated corncob powders.

FIG. 5 illustrates that carboxymethylation of corncob powder followed by reaction with soy protein isolate also produced changes in the spectrum between 1400 and 1700 cm⁻¹. The most significant change was the appearance of C═O stretching bands, consistent with carboxymethylation and the presence of protein. These spectral occurrences suggest the formation of a complex of carboxymethylated corncob powder and soy protein isolate.

Differential scanning calorimetry of as-received corncob powder revealed two exothermic transitions. The first started at 41.8° C. with a peak temperature of 80.38° C. and an associated enthalpy change of −57.13 J/g. The second transition began at 156.90° C. with a peak temperature of 179.88° C. and an associated enthalpy change of −1.68 J/g. All subsequent derivatizations of corncob powder did produce significant changes in these two exothermic transitions. Such derivatizations produced negligible changes in the onset temperatures, the peak temperatures, and the enthalpy changes associated with both exothermic transitions. All specimens exhibited brittle behavior in mechanical properties tests. Except in the case of succinylation, the lower degree of derivation produced larger amounts of shrinkage and higher strengths as shown in Table II. Carboxymethylation led to the strongest pellets, with strengths as high as 28.9 MPa.

TABLE II
Effects of the derivatization of corncob powder on
the shrinkage and tensile strength of pellets made
of reaction products with soy protein isolate.^{a}

| DERIVATIZED | | AVERAGE PELLET SIZE | | |
|---|---|---|---|---|
| CORNCOB | | DUE TO SHRINKAGE^{b} | | |
| IN REACTION | | DIAMETER | THICKNESS | STRESS |
| PRODUCTS | | mm | mm | MPa |
| Carboxymethylated | (A) | 6.4 ± 0.3 | 3.6 ± 0.2 | 20.7 ± 12.6 |
| | (B) | 5.9 ± 0.4 | 3.4 ± 0.1 | 28.9 ± 7.5 |
| Maleinated | (A) | 9.4 ± 0.5 | 5.0 ± 0.4 | 2.4 ± 1.4 |
| | (B) | 9.1 ± 0.5 | 4.7 ± 0.4 | 5.1 ± 2.4 |
| Glutarated | (A) | 8.1 ± 1.8 | 5.9 ± 1.8 | 3.3 ± 2.3 |
| | (B) | 7.7 ± 0.8 | 4.5 ± 0.4 | 9.6 ± 4.0 |
| Phthallated | (A) | 8.1 ± 1.9 | 5.5 ± 1.9 | 1.2 ± 0.5 |
| | (B) | 9.0 ± 0.4 | 4.6 ± 0.3 | 3.0 ± 1.5 |
| Succinylated | (A) | 9.2 ± 0.5 | 5.1 ± 0.4 | 2.7 ± 1.3 |
| | (B) | 9.6 ± 0.4 | 4.9 ± 0.8 | 1.4 ± 0.9 |

^{a}Values (A) are for pellet preparations of a higher degree of derivatization (at 0.2 moles of reactant) and (B) values are for the preparations of a lower degree of derivatization (at 0.1 moles of reactant).
^{b}Original dimensions of pellets prior to drying were 12.5 mm diameter by 8 mm thick

### Example 3

### Sawdust

The sawdust used herein was provided by Putt, Incorporated, Freeland, Mich. and was hardwood chips known as Hardwood Tender Turf. The chips were pulverized in a kitchen blender and size fractionated using a series of sieve screens. The fine fraction that passed through a 30 mesh screen, was used in the derivatizations.

In the acylation procedure, fifty grams of the pulverized and sized fines were suspended in 1.0 M aqueous NaOH solution (50 ml) and agitated for 24 hours and handled as in Example 1.

The carboxymethylation was handled as in example 1.

Formation of reaction products of derivatized hardwood and isolated soy protein was carried out by dissolving 5 grams of isolated soy protein in deionized water (100 ml) and the derivatized hardwood powder (5 grams) was admixed therein. The reaction mixture was agitated for 24 hours in a closed container, followed by centrifugation for 30 minutes at 6000 rpm. Supernatants were decanted and the resulting centrifuge cakes were transferred into a pellet mold as in example 1 and pellets were molded. In addition, a group of medium intensity bands formed between 1300 and 1400 cm⁻¹, which is a spectral region in which vibrations of ionized carboxylic groups occur.

Changes in the spectrum were caused by the reaction of acylated corncob powder. FIG. 5 illustrates this observation in the case of succinylated corncobs. Evident is the appearance of C═O peaks from the succinic anhydride as well as protein bands (1500-1700 cm⁻¹). The presence of these peaks supports the formation of a complex between protein and succinylated corncob. Essentially the same spectral changes were observed for reaction products of soy protein with the other acylated corncob powders.

FIG. 5 illustrates that carboxymethylation of corncob powder followed by reaction with soy protein isolate also produced changes in the spectrum between 1400 and 1700 cm⁻¹. The most significant change was the appearance of C═O stretching bands, consistent with carboxymethylation and the presence of protein. These spectral occurrences suggest the formation of a complex of carboxymethylated corncob powder and soy protein isolate.

Differential scanning calorimetry provided data of low precision, because corresponding peaks were broad and shallow. As-received and pulverized hardwood powder that was not soaked in NaOH exhibited onset and peak temperatures at approximately 129.1 and 143.5° C., respectively, with a corresponding enthalpy change of −2.45 J/g. Derivatization of hardwood powder and subsequent reaction with isolated soy protein produced materials of lower onset and peak temperatures, however, the enthalpy changes decreased by an order of magnitude. This suggests the formation of reaction products.

Mechanical property tests indicate brittle behavior of all specimens tested. Table III illustrates the effects of the type of derivatizations on the mechanical properties of reaction products between derivatized hardwood powder and soy protein isolate. Non-derivatized hardwood powder, after soaking in aqueous NaOH solution, formed a reaction product with soy protein isolate that had relatively low mechanical strength at 0.9 MPa. Higher strengths of up to 2.6 MPa were provided when hardwood powder was derivatized and subsequently reacted with soy protein isolate. Glutaration and maleination led to pellets with the highest strengths. All reaction products moderately shrank upon drying, suggesting that these materials are suitable for making reaction product shapes.

TABLE III
Effects of derivatization of hardwood powder
on the drying shrinkage and tensile strength of
reaction products with soy protein isolate

| | AVERAGE PELLET | | | | | |
|---|---|---|---|---|---|---|
| | SIZE DUE TO | | | | | |
| | SHRINKAGE^{a} | | | | TENSILE | |
| | DIAMETER | | THICKNESS | | STRENGTH | |
| DERIVATIZATION | mm | | mm | | MPa | |
| METHODS | | ± | | ± | | ± |
| Soaked in NaOH^{b} | 11.1 | 0.5 | 7.5 | 0.6 | 0.9 | 0.5 |
| Carboxymethylated | 10.9 | 0.9 | 5.7 | 0.9 | 1.6 | 1.2 |
| Glutarated | 10.7 | 0.7 | 6.9 | 0.6 | 1.3 | 1.0 |
| Maleinated | 10.1 | 0.4 | 6.2 | 0.6 | 2.4 | 0.8 |
| Phthallated | 10.7 | 0.4 | 6.6 | 0.7 | 1.3 | 0.7 |
| Succinylated | 10.8 | 0.4 | 6.7 | 0.3 | 1.4 | 0.5 |

^{a}Original dimensions of pellets were 12.5 mm by 8 mm thick.
^{b}Non-derivatized specimens

### Example 4

Corn distillers' dry grain, shredded corncob powder, hardwood powder, and shredded sugar beet pulp were separately oxidized with sodium hypochlorite. Infrared spectra and differential scanning calorimetry suggested that soy protein isolate formed reaction products with all of the above noted oxidized materials.

The Monitor Sugar Company, Bay City, Mich., provided the sugar beet pulp. The dry pulp contained 40% of pectin, 19.6% of cellulose, 18.0% of hemicellulose, 3.2% of sucrose and 1.5% of other components. Dried pulp was pulverized in a kitchen blender and size fractionated using a series of sieve screens. The fine fraction passed through a 30 mesh screen.

The sodium hypochlorite was Clorox bleach manufactured by the Clorox Company, Oakland, Calif. and contained 6% sodium hypochlorite. The Monitor Sugar Company, Bay City, Mich., provided the molasses raffinate, a source of protein. The material had a pH of 7.6, a density of 1300 kg/m³, with 60% of total solids including 22% sucrose, 5% raffinose, 22.0% crude protein, 0.5% amino acids, and 30% ash.

Samples were prepared wherein 20 grams of DDG, hardwood powder, corncob powder, dried sugar beet pulp powder and minced wet sugar beet pulp were each suspended in a separate 1 M aqueous solution of NaOH (80 ml) and agitated for 24 hours at room temperature in sealed flasks. Bleach solution (200 ml) was subsequently added to each suspension, and agitation continued for an additional 24 hours in non-hermetically sealed flasks. In each flask, white precipitate formed. The precipitate was separated from each specimen by centrifugation for 30 minutes at 6000 rpm and either dried in air or subjected to complexation with soy protein isolate.

Reacting oxidized materials with soy protein was handled by dissolving 5 grams of soy protein isolate in deionized water (100 ml) followed by admixing a derivatized sample (5 grams) of each of the above described materials separately with soy protein. The reaction mixture was agitated for 24 hours in a sealed container, followed by centrifugation for 30 minutes at 6000 rpm. Supernatants were decanted and the resulting centrifuge cakes were transferred with a spatula into a pellet mold placed on a flat ceramic surface. The molding was handled as set forth above in example 1.

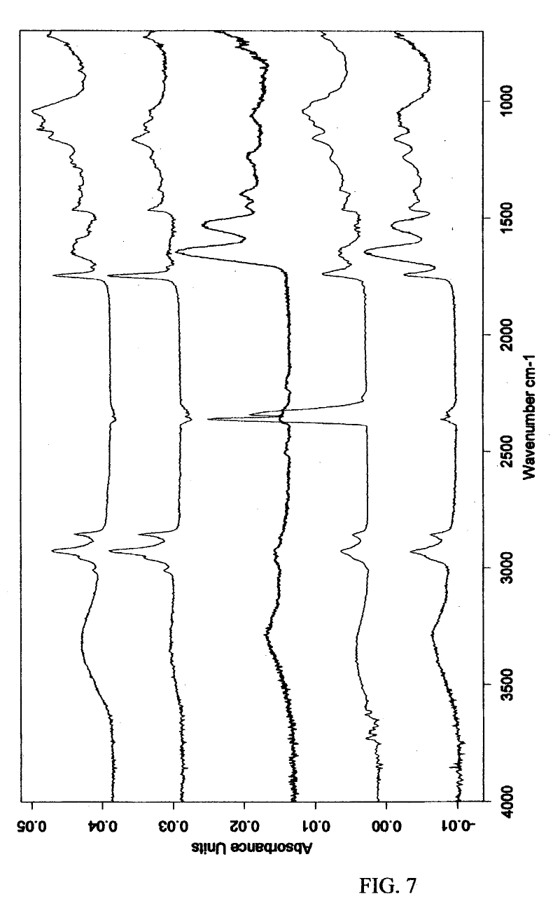

The spectrum (FIG. 7) of pulverized DDG before derivatization contains bands in the regions of 100-1200, 122-1500, and 1500-1700 cm⁻¹, which can be respectively assigned to C═O stretching, OH bending, and C—O stretching modes. Protein present in DDG might be manifested by bands incorporated in the region of 1500-1700 cm⁻¹ in FIG. 7. This is suggested from comparison of the spectrum of pulverized DDG with the spectrum of soy protein isolate in FIG. 7. Soaking DDG in the aqueous solution of NaOH produced changes in the IR spectrum, particularly in the regions of 1500-1700 cm⁻¹ and also at 3400 cm⁻¹. Changes are also visible in the group of intensive bands in the C—O stretching region of 1000-1200 cm⁻¹, with subtle changes also in the 1200-1500 cm⁻¹ region. These changes suggest that soaking in NaOH influenced the hydroxyl groups in the polysaccharide portion of DDG.

Subsequent oxidation of DDG from exposure to bleach solution produced further changes in the spectrum, mainly in the bands associated with hydroxyl group vibrations in the regions of 3400 and 1200-1500 cm⁻¹ as shown in FIG. 7. Subsequent admixture of soy protein isolate with the aqueous suspension of oxidized DDG instantly precipitated a solid reaction product with an infrared spectrum exhibiting strong features of both protein and oxidized DDG.

Differential scanning calorimetry showed that oxidation of DDG resulted in a reduction in both the onset and peak temperature, indicating that the oxidized material is less thermally stable than as-received DDG. In addition, oxidized DDG exhibited a stronger exothermic transition, which suggests stronger interactions of functional groups in this material. Subsequent reaction of oxidized DDG with soy protein isolate produced a significant increase in thermal stability. However, the reaction product was weak, based on the significant increase of the change of enthalpy of the transition (see TABLE IV).

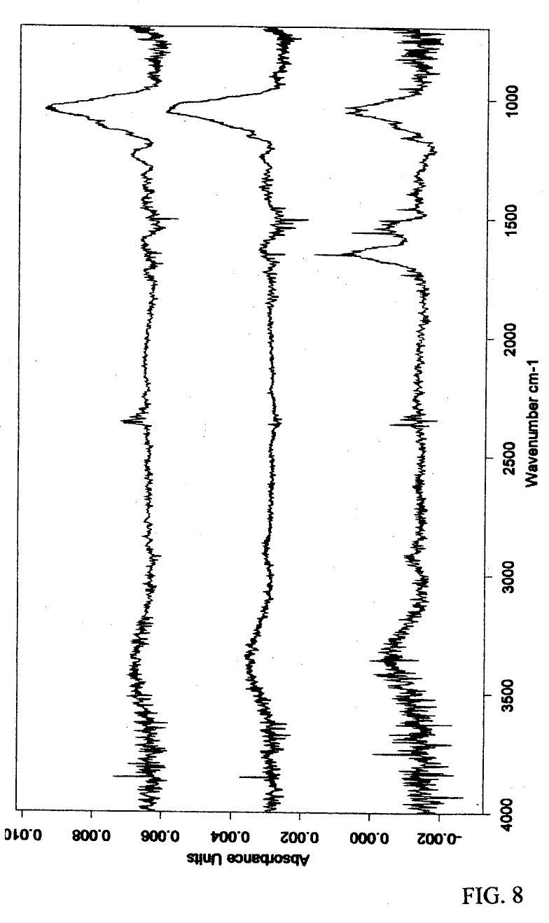

The oxidation of hardwood powder also resulted in subtle changes in the infrared spectra as shown in FIG. 8. In particular, oxidation increased the intensity in the hydroxyl group vibration at 3400 cm⁻¹. Similarly to the case of oxidized DDG, complexation of oxidized hardwood powder with protein caused instantaneous separation of the reaction product from solution. The spectrum (FIG. 8) of the reaction product exhibited strong features of both protein and hardwood powder.

Differential scanning calorimetry indicated that reaction products of protein with oxidized hardwood powder were more thermally stable than either the oxidized or non-oxidized hardwood specimens. The order of magnitude decrease in the enthalpy change suggests that the protein reaction product was more stable than oxidized hardwood powder prior to complexing.

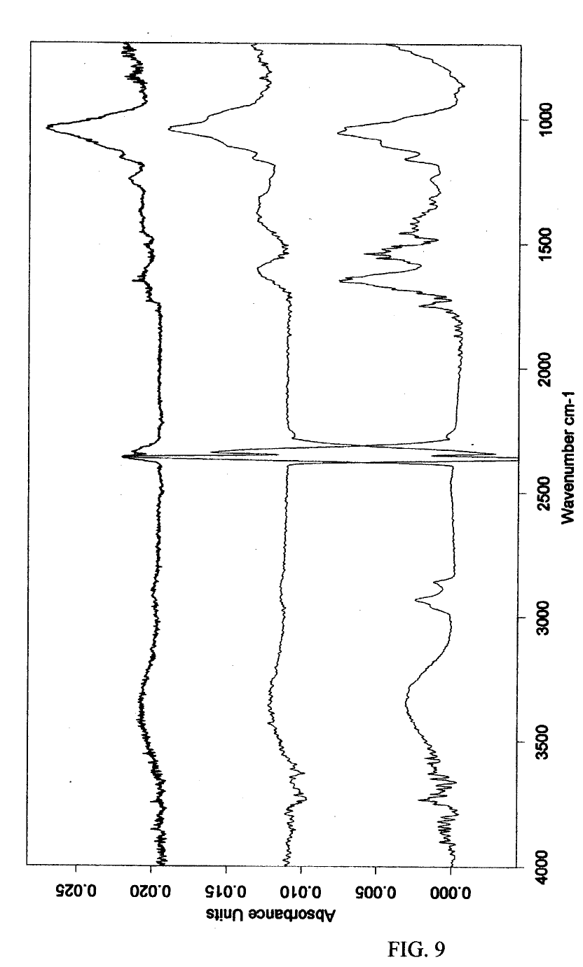

FIG. 9 presents infrared spectra of corncob powder, oxidized corncob powder, and the reaction product of oxidized corncob powder with soy protein isolate. Oxidation of corncob powder significantly changed in the infra red spectrum, mainly in the bands associated with hydroxyl group vibrations in the regions of 3400 and 1200-1500 cm⁻¹. Similarly to the previous cases, admixing protein with oxidized corncob powder caused instantaneous separation of the reaction product from solution. The spectrum of the reaction product exhibited strong features of both oxidized corncob powder and protein.

Similarly as in the previous cases of DDG and hardwood powder, reaction products of protein with oxidized corncob powder provided a material with higher thermal stability than either the oxidized or non-oxidized corncob powder. Minor differences in the changes of the enthalpy of transitions point to the formation of a weak reaction product.

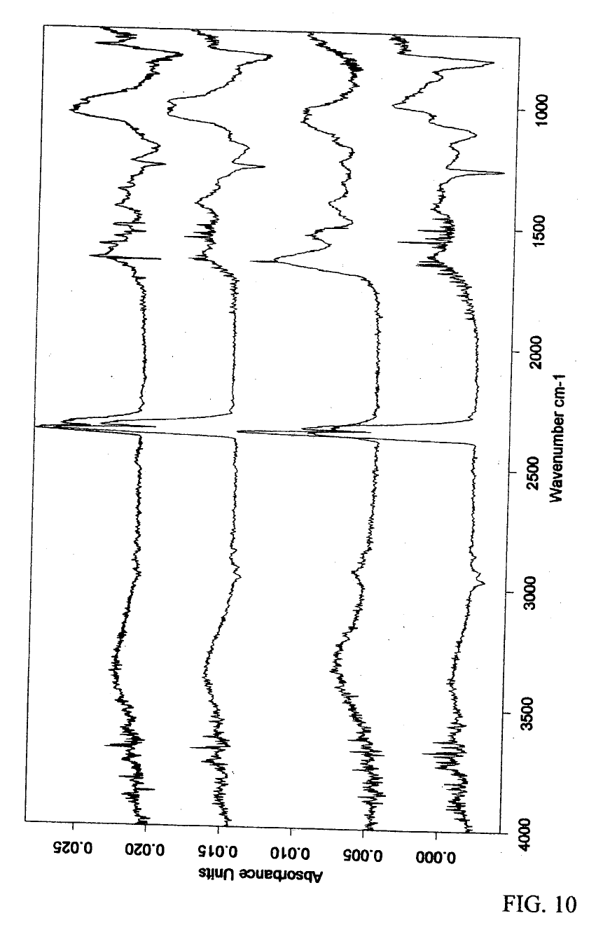

It is essential to de-methylate pectins in sugar beet pulp in order to provide a sufficient number of anionic reaction sites capable of reacting with proteins. Taking this fact into account, prior to admixing with protein, either dry or wet sugar beet pulp was soaked in aqueous NaOH solution. Such soaking of either dry or wet sugar beet pulp resulted in the formation of a swollen, gelatinous material. However, only subtle changes in the infrared spectra of sugar beet pulp were observed before and after soaking in NaOH (FIG. 10). Subsequent oxidation of sugar beet pulp produced only minor changes in the C—O stretching (1000-1200 cm⁻¹) and OH bending (1200-1500 cm⁻¹) regions. Again, similar to the previous cases, subsequent admixing of protein with oxidized sugar beet pulp caused instantaneous separation of the reaction product from solution. As shown in FIG. 10, the spectrum of the reaction product exhibited strong features of both oxidized sugar beet pulp and protein.

As shown in TABLE IV, the reaction product of soy protein with oxidized sugar beet pulp had a much lower enthalpy of transition than corresponding enthalpies for all other protein-polysaccharide reaction products in this study.

As shown in Table V, tensile strengths as high as 9.5 MPa were observed in pellets formed of protein reaction products with either oxidized corn distiller' dry grain or oxidized dried sugar beet pulp. Strengths as high as 3.9 MPa were observed in pellets that were prepared from protein reaction products with oxidized wet sugar beet pulp. Much lower strengths were produced by soy protein reaction products with either oxidized hardwood powder or oxidized corncob powder. All pellets were hard, brittle, and non-sticky to the touch. In one of the experiments with oxidized and dried sugar beet pulp, molasses raffinate was used as a source of protein. The resulting pellets were soft and sticky to the touch.

TABLE IV
Differential scanning calorimetry of original and hypochlorite
oxidized materials as well as their reaction products with soy protein

| | | | CHANGE OF |
|---|---|---|---|
| | TEMPERATURE ° C. | | ENTHALPY |
| TYPE OF SAMPLE | ONSET (Tₒ) | PEAK (Tₚ) | -ΔH/Jg |

Corn Distillers' Dry Grain

| | | | |
|---|---|---|---|
| Non-treated | 91.90 | 133.40 | 86.68 |
| Oxidized | 51.23 | 101.69 | 92.87 |
| Oxidized/Protein Reacted | 132.54 | 156.63 | 3.86 |

Hardwood Powder

| | | | |
|---|---|---|---|
| Non-treated | 129.09 | 143.50 | 2.45 |
| Oxidized | 116.29 | 119.68 | 1.35 |
| Oxidized/Protein Reacted | 147.39 | 180.06 | 13.74 |

Corncob Powder

| | | | |
|---|---|---|---|
| Non-treated | 156.90 | 179.88 | 1.68 |
| Oxidized | 162.92 | 167.13 | 0.48 |
| Oxidized/Protein Reacted | 202.62 | 207.00 | 0.28 |

Sugar Beet Pulp

| | | | |
|---|---|---|---|
| Non-treated | 66.98 | 114.81 | 26.31 |
| Oxidized | 88.64 | 155.31 | 45.81 |
| Oxidized/Protein Reacted | 129.02 | 148.68 | 51.85 |

Soy Protein Isolate

| | | | |
|---|---|---|---|
| Non-treated | 87.23 | 130.56 | 36.78 |

^{a}The average estimation error for all cases does not exceed ± 20%.

TABLE V
Measurements of the drying shrinkages and tensile
strengths of pellets made of protein reacted with
oxidized agricultural waste materials

| | AVERAGE PELLET | | | | | |
|---|---|---|---|---|---|---|
| | SIZE DUE TO | | | | TENSILE | |
| | SHRINKAGE | | | | STRENGTH | |
| DERIVATIZED | Diameter/mm | | Thickness/mm | | MPa | |
| METERIAL | | ± | | ± | | ± |
| Corn distillers' dry | 7.2 | 0.3 | 3.8 | 0.3 | 9.5 | 2.3 |
| grain | | | | | | |
| Hardwood powder | 9.0 | 0.6 | 4.2 | 0.4 | 1.3 | 0.5 |
| Sugar beet pulp (dry)^{b} | 7.0 | 0.2 | 4.1 | 0.2 | 9.2 | 2.1 |
| Sugar beet pulp (dry)^{c} | 9.2 | 1.4 | 5.6 | 1.5 | 1.8 | 0.2 |
| Sugar beet pulp (wet) | 6.7 | 0.2 | 3.9 | 0.2 | 3.9 | 1.3 |
| Corncob powder | 8.0 | 0.4 | 4.9 | 0.3 | 3.4 | 1.1 |

^{a}Original size of pellets was 12.5 mm diameter by 8 mm thickness.
^{b}From derivatized, dry pulverized pulp and reacted with soy protein isolate
^{c}From derivatized, dry pulp and reacted with protein in molasses.

What is claimed is:

1. A method for the preparation of biodegradable plastics, said method comprising:
(I) providing a suspension in a basic aqueous carrier of a finely divided natural material containing a saccharide selected from the group consisting of
(i) polysaccharides,
(ii) oligosaccharides, and
(iii) a combination of (i) and (ii);
(II) adding water to the suspension;
(III) agitating the suspension for a period of time;
(IV) subjecting the product resulting from step (III) to derivatization selected from the group consisting of:
(A) acylation using a material selected from the group consisting of cyclic anhydrides selected from the group consisting of
(i) maleic anhydride,
(ii) succinic anhydride,
(iii) glutaric anhydride,
(iv) phthalic anhydride and,
(v) derivatives of (i), (ii), (iii), and (iv);
(B) carboxymethylation using materials selected from the group consisting of:
(i) haloalkanoic acids and
(ii) salts of haloalkanoic acids, and,
(C) oxidation using an oxidizing agent selected from the group consisting of:
(a) hypochlorites;
(b) hydrogen peroxide;
(c) ozone and
(d) air, to provide a solid anionic material, and thereafter,
(V) combining the material resulting from (IV) with a protein and allowing the resulting material and the protein to react with each other.

2. A plastic prepared by the method of claim 1.

3. A method as claimed in claim 1 wherein the natural material is selected from the group consisting of:
(i) starchy materials,
(ii) cellulosic materials,
(iii) lignocellulosic materials,
(iv) hemicellulosic materials,
(v) plant gum containing materials,
(vi) polysaccharide-containing materials and,
(vii) oligosaccharide-containing materials.

4. A method as claimed in claim 1 wherein the natural material is selected from the group consisting of:
(i) plant tubers
(ii) wheat
(iii) seeds
(iv) shells of seeds
(v) stems
(vi) roots
(vii) leaves of plants
(vi) fruit
(vii) fruit skins
(viii) wood
(ix) tree branches
(x) tree bark
(xi) straw
(xii) grass
(xiii) distiller dry grain
(xiv) sugar beet pulp
(xv) cellulose pulp
(xvi) paper waste
(xvii) cotton
(xviii) linen
(xix) vegetables
(xx) vegetable skins.

5. A method as claimed in claim 1 wherein the protein is selected from the group consisting of:
(i) soy protein isolate,
(ii) casein separated from milk,
(iii) casein dispersed in milk,
(iv) whey protein isolate,
(v) whey protein,
(vi) potato protein,
(vii) ovalbumin,
(viii) animal albumins,
(ix) blood protein, and
(x) molasses raffinate.
